(19) United States
(12) Patent Application Publication
(10) Pub. No.: US 2002/0095738 A1
(43) Pub. Date: Jul. 25, 2002

(54) Easily manipulated paint roller having a telescopic handle

(76) Inventors: Frederic Lallement, La Capelle (FR); Pascal Fievet, La Capelle (FR)

Correspondence Address: JACOBSON HOLMAN PLLC, 400 SEVENTH STREET N.W., SUITE 600, WASHINGTON, DC, 20004, US

(21) Appl. No.: 09/764,363

(22) Filed: Jan. 19, 2001

(51) Int. Cl. B05C 17/02; B25G 1/04

(52) U.S. Cl. 15/144.4; 15/230.11; 16/429; 492/13; 492/19

(57) ABSTRACT

The invention provides a paint roller having a telescopic handle, the handle comprising an inner element (200) and an outer element (100) that slide one in the other, the inner element (200) carrying a member (220) for co-operating with the outer element to prevent sliding, the outer element having an outwardly-directly longitudinal slot, said member traveling along said slot and remaining uncovered while sliding, the roller being characterized in that the longitudinal slot (105) forms a series of arrangements (135) in its longitudinal edges suitable for retaining said member (220, 225) against sliding.

The present invention relates to paint rollers with telescopic handles.

Numerous rollers of this type have been proposed.

Document U.S. Pat. No. 5,502,864 thus proposes a simple arrangement having two elements that slide one in the other, with the inner element carrying a projection that can be extended radially by relative rotation between the two elements.

The projection then presses hard enough against the inside faces of the outer element to prevent any subsequent sliding.

Document U.S. Pat. No. 5,220,707 likewise proposes fitting a sliding outer handle with a finger that penetrates radially into the inside thereof to come into abutment against an internal rod under the effect of resilient return means.

In that arrangement, the outer handle has a large radial projection whose function is to hold the finger firmly while still leaving it free to move radially a little. Such a projection encumbers the handle and makes it difficult to manipulate.

Document U.S. Pat. No. 4,325,147 also proposes a roller with two tubes engaged one in the other, the outer tube having a series of orifices in alignment and the inner tube having a resiliently biased tongue carrying a peg designed to penetrate in one of the orifices.

Although such an arrangement makes it possible to leave a large area of the outer tube free to be grasped, it suffers from the drawback of being difficult to adjust because it is difficult to extract the peg completely from its orifice.

In particular, the user must take hold of one tube in each hand in order to move them relative to each other, and this can be particularly bothersome when the handle is soiled with paint.

The main object of the invention is to resolve those drawbacks, i.e. to propose a roller having a telescopic handle which is both easy to adjust and which does not have a projection that impedes grasping the handle.

The invention provides a paint roller having a telescopic handle, the handle comprising an inner element and an outer element that slide one in the other, the inner element carrying a member for co-operating with the outer element to prevent sliding, the outer element having an outwardly-directed longitudinal slot, said member traveling along said slot and remaining uncovered while sliding, the roller being characterized in that the longitudinal slot forms a series of arrangements in its longitudinal edges suitable for retaining said member against sliding.

Other characteristics, objects, and advantages of the invention will appear more clearly on reading the following detailed description, given with reference to the accompanying figures, in which:

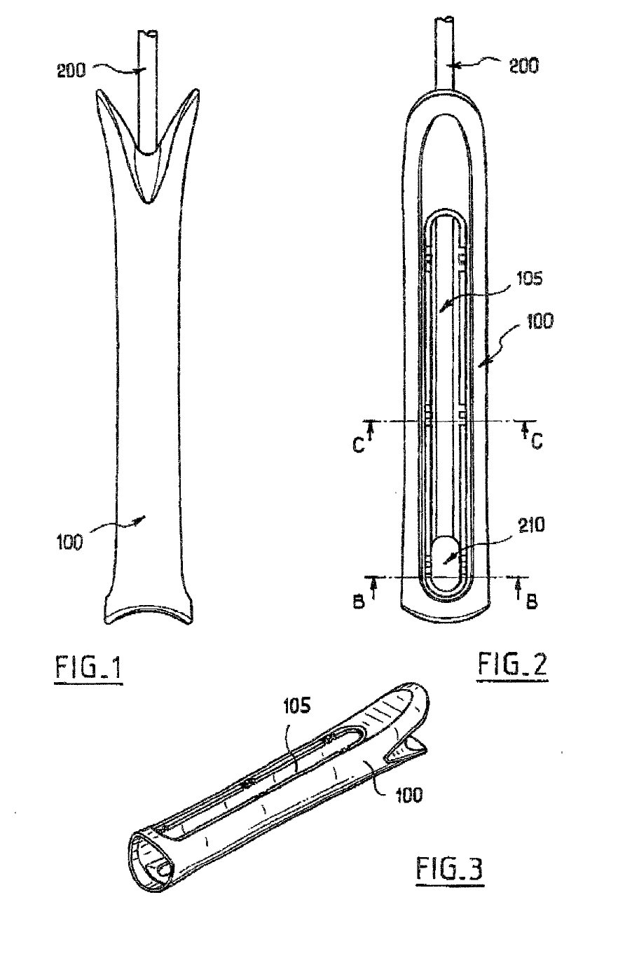

FIG. 1 is a side view of a handle of a roller of the invention;

FIG. 2 is a plan view of the said handle;

FIG. 3 is a perspective view of the said handle;

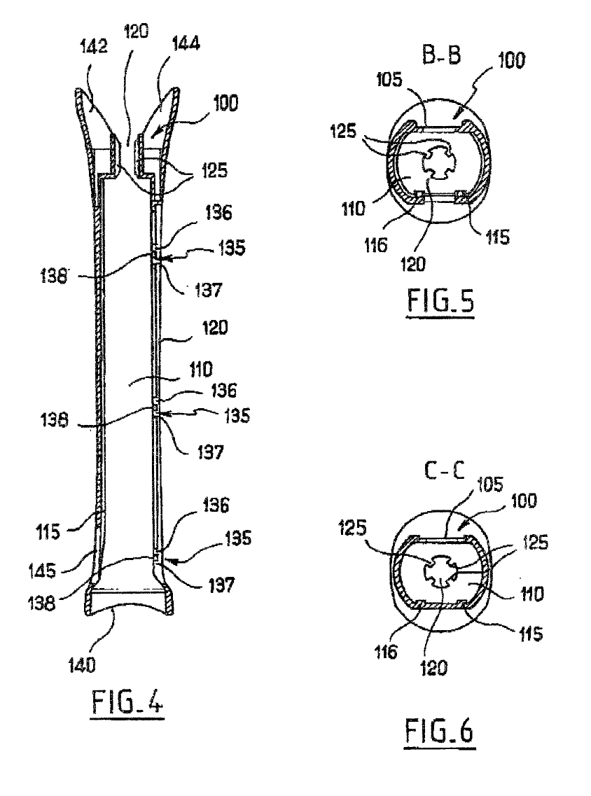

FIG. 4 is a longitudinal section view of said handle;

FIGS. 5 and 6 are two cross-section views of different locations of said handle;

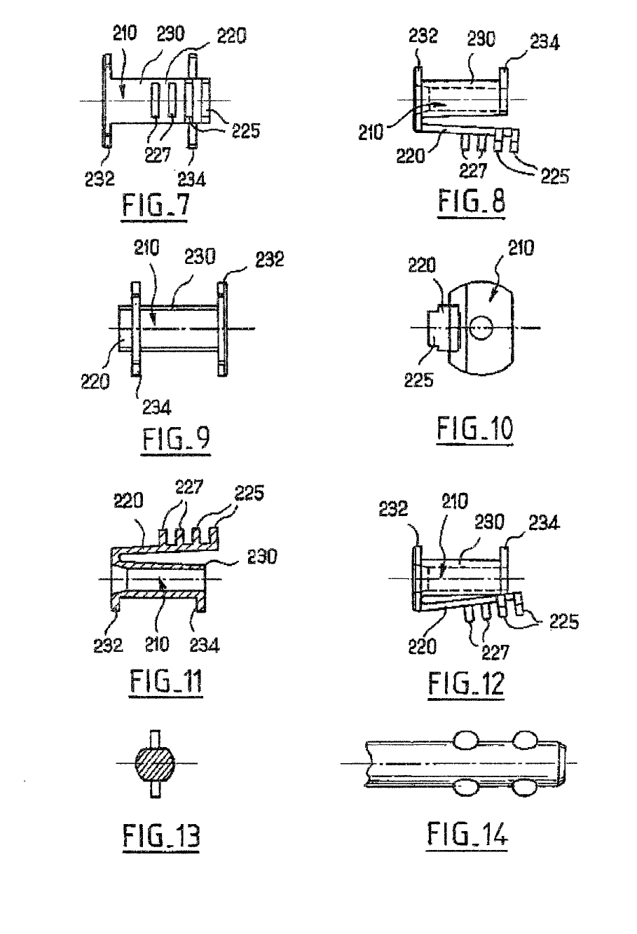

FIGS. 7, 8, 9, and 10 are respectively a plan view, a side view, an under view, and a rear view of a slide of the invention;

FIG. 11 is a longitudinal section view of said slide;

FIG. 12 is a side view of said slide in a compressed state;

FIG. 13 is an end view of an end portion of a rod of the invention; and

FIG. 14 shows the rod in side view.

The present roller comprises a metal rod 200 which, in conventional manner, has one end forming a shaft on which a textile sleeve rotates, and has its opposite end penetrating into a handle 100.

This second end co-operates with the handle 100 via telescopic means described below.

The handle 100 constitutes an enclosure around a main channel 110 running along the handle 100 over most of its length. The channel 100 has a longitudinal slot 105 on one side which leaves the handle open towards the user.

In addition, the channel 110 is extended where the rod 200 exits by a passage 120 of considerably smaller diameter and referred to below as a “throat”.

The end of the rod 200 which comes into the handle 100 carries a piece 210 which is fitted to the rod 200 after it has been engaged in the handle 100. The transverse dimensions of this piece 210 are equal to the dimensions of the inside space of the channel 110. This end piece thus slides without play inside the channel The rod 200 when installed in this way passes through the throat 120 with practically no play, but also without being forced.

The slide 210 and the running portion of the rod 200 are of dimensions that are complementary to the portions of the handle that receive them, i.e. the main channel 110 and the throat 120, so the rod 200 is held transversely both at its rear end and where it comes out from the handle 100.

The inside of the handle 100 is shown in greater detail in FIGS. 5 and 6.

The transverse shape of the channel 110 is substantially rectangular, with the shorter sides of the rectangle being arcuate, bulging outwards. In other words, the internal outline of a section of the channel 110 corresponds to a disk which has had two diametrically opposite segments removed on two mutually parallel lines that are at equal distances from the center.

As shown in FIG. 10, the slide 210 has a cross-section of similar dimensions, thus having two opposite rectilinear faces corresponding to the internal rectilinear faces of the channel 110.

Once in place inside the channel 110, the slide 210 is thus prevented from pivoting inside the handle 100.

As can be seen in FIGS. 5 and 6, the throat 120 forms four studs 125 on its inside wall that are uniformly distributed angularly and that extend inwards over a short distance.

The diameter of the metal rod 200 is equal to the diameter of a circle passing via the tips of each of the studs 125. Thus, the metal rod 200 when passing through the throat 120 comes into contact only with the ends of the studs 125. These studs 125 hold the rod 200 without slack, but they do not prevent it from sliding because they present friction surfaces of small area relative thereto.

The main channel 110 also has projecting elements for coming into contact with the slide 210 without giving rise to large friction areas.

On its inside face opposite the face having the slot 105, the channel has two longitudinal rails 115 and 116 extending substantially in register with the side edges of said face. The slide 210 thus rests on the rails 115 and 116 and slides along them.

In the present embodiment, the slide 210 is made as an element for locking movement in translation. On its face directed towards the slot 105 it has a resilient tongue 220 which extends away from the body of the slide from the end of the slide which is closer to the rod.

This tongue 220 is designed to penetrate into the slot 105 and to co-operate with retaining recesses formed in the edges of the slot.

Thus, at its free end, the tongue 220 has four outwardly projecting ridges 225, 227 that are perpendicular to the axis of the slide 210. The two ridges 225 situated at the free end of the tongue 220 are of width that is greater than that of the main portion of the slot 105 and thus come into abutment against the edges of the slot 105 in the main portions thereof.

In certain positions of the slide, these ridges nevertheless penetrate through recesses formed in its edges and then lock the slide 210 against sliding.

These two ridges 225 also taper towards the outside of the slide 210 so that when the user pushes them into the channel their portions that might be pushed into the slot 105 are of reduced width and spaced apart from the longitudinal edges of the slot 105.

These two ridges 225 extend from a top face of the tongue 220 and the bases of the ridges have the same width as the tongue 220.

Arrangements 135 for retaining the slide 210 are formed on the edges of the slot 105 and are constituted by recesses 136, 137 having the same thickness as the ridges 225 and a depth such that the distance between the bottoms of two such recesses placed on either side of the slot is equal to the width of the ridges 225 at the bases thereof.

On each occasion, a retaining arrangement 135 of the slot 105 is constituted by two pairs of such recesses 136 and 137, one pair on either side of the slot 105, so as to receive both ridges 225 simultaneously.

On each occasion, the two recesses 136 and 137 of a pair are separated by a short stud 138 pointing towards the inside of the slot 105. The stud 138 and the edges of the slot 105 that are directly adjacent to the recesses 136 and 137 thus bear against the top face of the tongue 220.

Although the general shape of the ridges 225 is substantially rectangular, they nevertheless taper slightly in width towards the slot 105 so as to penetrate into the recesses 136 and 137 without jamming under the return force of the tongue 220. The top edge of each ridge 225 thus has two side slopes at 45°.

In the locked position, the ridges 225 and 227 thus extend across the slot 105 and present their top edges flush with the top surface of the handle 100. The slide 210 thus lies within the volume of the handle 100 and does not impede manipulation of the handle 100. The slide 210 is particularly practical for adjusting the length of the rod projecting from the handle merely by pressing down with the thumb (it should be observed that during such action, the four ridges 225, 227 form a non-slip arrangement for the user's thumb).

To further limit friction between the slide 210 and the bottom wall of the channel 110, the slide 210 presents two parallel walls 232 and 234 in its bottom portion that are integrally molded with the main body of the slide, and that are located at opposite ends of the slide, i.e. one at the rod end and the other at the end furthest from the rod. These walls 232 and 234 extend across both of the rails 115 and 116 so as to form a total of four bearing points. The user thus encounters very small friction forces opposing sliding of the slide 210.

To slide the rod 200 along the handle 100, the user begins by disengaging the ridges 225 from the arrangements 135 in the edges of the slot 105 by applying pressure on the tongue 220 towards the inside of the channel 110. This pressure releases the ridges 225 enabling the user to push the slide by applying thrust obliquely via the thumb.

This reduction in contact areas is thus particularly advantageous for the slide remote from its end that receives thrust from the thumb. This reduction in the contact areas also serves to avoid the slide becoming jammed, e.g. because of an adhesion effect produced by drops of paint drying between the slide and the handle.

For fixing to the rod 200, the slide 210 has a simple longitudinal channel 230 of inside dimensions that are slightly smaller than the diameter of the rod 200 so as to receive the rod as a force-fit. The slide 210 is prevented from rotating by four lugs punched in the surface of the rod 200 in the zone of the rod 200 that is to penetrate into the slide 210, as shown in FIGS. 13 and 14. These lugs are for forcing into the slide 210. The internal channel 230 flares slightly towards the rod 200 to make it easier to insert during assembly.

The punched lugs are disposed in a diametrically opposite configuration on the rod 200. The above-described studs 125 are distributed in such a manner as to allow the lugs to pass between them while the roller is being assembled.

The handle 100 presents an opening at its rear end that is large enough to enable the slide 210 to be inserted into the handle 100, said opening having a funnel-shaped inside wall to facilitate such insertion. In the vicinity of this end of the handle, the handle also presents an orifice 145 in a position diametrically opposite to the slot 105 to enable the handle to be hooked onto a peg.

The handle 100 described above has an outline in the form of a circle that is truncated by two diametrically opposite parallel flats, both parallel to the general plane of the roller. One of these flats includes the longitudinal slot 105.

The two flats of the handle 100 are extended at their ends adjacent to the rod 200 by two sloping portions which flare away from the main plane of the roller on either side of that portion of the rod 200 which comes out from the handle 100, thus providing hooks that enable the roller to be suspended from the edge of a receptacle containing paint.

1/ A paint roller having a telescopic handle, the handle comprising an inner element (200) and an outer element (100) that slide one in the other, the inner element (200) carrying a member (220) for co-operating with the outer element to prevent sliding, the outer element having an outwardly-directed longitudinal slot, said member traveling along said slot and remaining uncovered while sliding, the roller being characterized in that the longitudinal slot (105) forms a series of arrangements (135) in its longitudinal edges suitable for retaining said member (220, 225) against sliding.

2/ A roller according to claim 1, characterized in that said member (220, 225) is configured to remain radially circumscribed within the outer element (100).

3/ A roller according to either preceding claim, characterized in that one of the inner and outer elements (200, 100), forms projections (115, 116, 125) extending towards the other element so as to form bearing zones between the two elements (100, 200) at the tips of these projections (115, 116, 125).

4/ A roller according to any preceding claim, characterized in that:
a) the outer sliding element (100) forms a channel (110, 120) with at least two portions (110, 120), namely a large portion (110), and a narrow portion (120); and
b) the inner element (200) forms a running portion having the same width as the narrow portion (120), and forms an enlarged portion (210) having the same width as the large portion (110).

5/ A roller according to the preceding claim, characterized in that the enlarged portion (210) of the inner sliding element forms said member (220, 225).

6/ A roller according to claims 3 and 4 in combination, characterized in that the projections (115, 116, 125) are formed on an inner wall of the narrow portion (120).

7/ A roller according to any preceding claim, in combination with claim 3, characterized in that the projections (115, 116, 125) constitute sliding rails (115, 116) on an inner wall of the outer element (110) for engaging the inner element (210).

8/ A roller according to claims 4 and 7 in combination, characterized in that the enlarged portion (210) carries said member (220, 225) and in that the rails (115, 116) are placed in positions such that the enlarged portion (210) is caused to bear against the rails (115, 116).

9/ A roller according to any preceding claim in combination with claims 4 and 7, characterized in that the enlarged portion (210) of the inner element (200) forms at least one wall (232, 234) extending transversely to the sliding direction and bearing against the rails (115, 116) via one of its edges.
